(19) United States
(12) Patent Application Publication
(10) Pub. No.: US 2011/0158663 A1
(43) Pub. Date: Jun. 30, 2011

(54) PRINTING APPARATUS, PRINTING METHOD, PRINTING SYSTEM, AND PROGRAM FOR IMPLEMENTING THE PRINTING METHOD

(75) Inventor: Masanori Matsuzaki, Kawasaki-shi (JP)

(73) Assignee: CANON KABUSHIKI KAISHA, Tokyo (JP)

(21) Appl. No.: 12/969,127

(22) Filed: Dec. 15, 2010

(30) Foreign Application Priority Data
Dec. 28, 2009 (JP) 2009-297378

(51) Int. Cl. G03G 15/01

(52) U.S. Cl. 399/39

(57) ABSTRACT

A printing apparatus includes a generation unit configured to generate first print data and second print data based on input print data, a printing unit configured to print the first print data generated by the generation unit on a sheet, an acquisition unit configured, in order to print the second print data on the sheet having the first print data printed thereon by the printing unit while reducing misregistration, to acquire a correction parameter used for correcting a position of printing the second print data, a transmission unit configured to transmit the second print data generated by the generation unit and the correction parameter acquired by the acquisition unit to a second printing apparatus, and a conveyance unit configured to convey the sheet having the first print data printed by the printing unit to a paper feed unit of the second printing apparatus.

### BACKGROUND OF THE INVENTION

1. Field of the Invention

The present invention relates to a printing apparatus, a printing method, a printing system, and a program for implementing the printing method. In particular, the present invention relates to a printing apparatus, a printing method, and a printing system configured to form an image on the same sheet by using a first toner and a second toner and by using a plurality of printing apparatuses, and a program thereof.

2. Description of the Related Art

Recently, an electrophotographic recording apparatus that uses a clear toner, which is a special printing material, has been introduced. A clear toner is a transparent printing material, which has a characteristic of adding a transparent image to color images.

By using a clear toner like this, images can be expressed in various ways. Accordingly, additional values of a resulting output product may increase. A conventional electrophotographic recording apparatus is capable of generating an output product generated by using a clear toner by using one electrophotographic recording apparatus including a mechanism or a method for adding a clear toner image to CMYK color toner images. However, in printing image data by using a special printing material such as the clear toner, the conventional electrophotographic recording apparatus may consume more amount of toners for printing in total compared to conventional printing by four color toners.

In particular, if the above-described conventional recording apparatus is used in electrophotographic color printing, it is necessary to transfer a special printing material image, which has been formed on an intermediate transfer member on CMYK four color toner images that have been formed by the above-described conventional method, on a sheet. In other words, the amount of applied toner, which is equivalent to the amount of toner necessary for printing for each electrophotographic process, may considerably increase. Accordingly, a large processing load may arise in each processing.

In order to solve the above-described problem, Japanese Patent Application Laid-Open No. 2007-011028 discusses a method for calculating the amount of applied recording agent that can be used in recording an image by using a special printing material based on the amount of applied toner of CMYK four color toners.

However, if the amount of applied special printing material is calculated according to the method discussed in Japanese Patent Application Laid-Open No. 2007-011028, the resulting amount of applied special printing material may become “0” in some cases. More specifically, the amount of applied special printing material may become “0” if the total amount of applied toner of four color toners exceeds the total amount of toners that can be effectively fixed on a sheet beyond the amount appropriately used on a printing apparatus. In this case, if a user has instructed printing that uses a special printing material, the printing that uses the special printing material instructed by the user cannot be executed. Accordingly, a visual effect of the special printing material on an output product intended by the user may not be achieved.

In order to solve the above-described problem, a conventional method discussed in Japanese Patent Application Laid-Open No. 2008-139589, if it is determined that printing instructed by a user, which uses a special printing material, cannot be executed by one fixing operation, changes the method for forming a special printing material image. More specifically, the conventional method prints and fixes images by using toners other than the special printing material and outputs a sheet having the fixed image. Furthermore, the conventional method prints an image by using a special printing material on the sheet having the printed toner images and fixes the image again. The printing method in which images are fixed twice is referred to as “2-pass printing”.

Using the 2-pass printing method enables printing an image by using an amount of special printing material more than a predetermined amount of special printing material, which is previously determined based on the total amount of applied recording agent that can be used on a printing apparatus. Therefore, in this case, printing that uses the special printing material instructed by a user can be executed. Accordingly, a visual effect of the special printing material on an output product intended by the user can be achieved.

By introducing a method that uses a clear toner, a problem that may otherwise arise, such as restriction of the toner amount, can be solved. However, if a user of the printing apparatus hardly or never uses the clear toner, the method compliant with a job using the clear toner may require unnecessary functions and adversely increase costs of manufacture of the apparatus.

In order to solve this problem, the following system may be useful. More specifically, in this system, a printing apparatus that uses color toners and another printing apparatus that uses a special printing material are provided separately from each other. Furthermore, a paper discharge unit of one (a first) printing apparatus, which uses color toners, and a paper feed unit of another (a second) printing apparatus, which uses the special printing material, are connected to each other.

In this system, an output product that is generated by using the special printing material can be completely generated within and under central control of the system. For a user who desires to execute printing using the special printing material, the system allows the user to use both the printing apparatus that uses color toners and another printing apparatus that uses the special printing material. On the other hand, for another user who does not desire to execute a print job that uses the special printing material, the system allows the user to use the printing apparatus that uses color toners only. By using the method in which two printing apparatuses having different functions are connected to each other, the system can print a job as desired by the user.

However, in forming an image in a system including two printing apparatuses connected with each other, a phenomenon of misregistration may more easily occur compared to a conventional case where an image is output by one printing apparatus. More specifically, if a printing apparatus that uses CMYK toners and another printing apparatus that uses a special printing material are used, images printed by using the CMYK toners and an image printed by using the special printing material are printed on the same sheet.

On the same sheet having the CMYK toner images and the clear toner image printed thereon, the images maybe printed in positional deviation from one another. If the amount of mutual positional deviation becomes too great (i.e., if great misregistration may occur), the misregistration occurring among images may become too conspicuous.

In addition, if an image is formed by using a printing system including two printing apparatuses connected with each other, it is more difficult to correct the misregistration compared to a case of forming an image by using one printing apparatus. This is because if one printing apparatus only is used, the misregistration can be automatically corrected by using a built-in sensor while if the printing system including two printing apparatuses is used, the image formed by the second printing apparatus cannot be formed on the images formed by the first printing apparatus without color misregistration because in this case, misregistration cannot be corrected by using a built-in sensor of each apparatus.

In addition, another misregistration may arise when a printing apparatus is installed in the system, i.e., when the printing apparatus that uses the clear toner is replaced with a new printing apparatus or a new printing apparatus having the performance higher than the existing printing apparatus. Accordingly, in the system including two mutually-connected printing apparatuses, the frequency of correction of misregistration becomes higher compared to a case of using one printing apparatus only.

### SUMMARY OF THE INVENTION

According to an aspect of the present invention, a printing apparatus includes a generation unit configured to generate first print data and second print data based on input print data, a printing unit configured to print the first print data generated by the generation unit on a sheet, an acquisition unit configured, in order to print the second print data on the sheet having the first print data printed thereon by the printing unit while reducing misregistration, to acquire a correction parameter used for correcting a position of printing the second print data, a transmission unit configured to transmit the second print data generated by the generation unit and the correction parameter acquired by the acquisition unit to a second printing apparatus, and a conveyance unit configured to convey the sheet having the first print data printed by the printing unit to a paper feed unit of the second printing apparatus.

According to an exemplary embodiment of the present invention, misregistration, which may occur in forming one image by using a plurality of printing apparatuses, can be effectively corrected.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the present invention.

FIG. 1 illustrates an exemplary configuration of a printing system according to an exemplary embodiment of the present invention.

FIG. 2 is a flow chart illustrating an exemplary flow of print processing including a clear job.

FIG. 3 is a flow chart illustrating an exemplary flow of copy processing including a clear job.

FIG. 4 is a flow chart illustrating an exemplary flow of image processing, which is executed by a color multifunction peripheral (MFP).

FIG. 5 is a flow chart illustrating an exemplary flow of image processing executed by a clear MFP, which includes processing for correcting misregistration.

FIG. 6 illustrates an example of rectangle data, which is used for outputting a chart.

FIG. 7 is a flow chart illustrating an exemplary flow of processing for calculating a parameter used for correcting misregistration that may occur among MFPs.

FIG. 8 illustrates an example of processing for calculating positional information about a rectangle.

FIG. 9 is a flow chart illustrating an exemplary flow of processing for calculating an offset amount.

FIG. 10 is a flow chart illustrating an exemplary flow of processing for calculating an adjustment parameter.

FIG. 11 is a flow chart illustrating an exemplary flow of processing for calculating a parameter used for correcting misregistration that may occur among MFPs, which is executed without using a scanner.

FIG. 12 is a flow chart illustrating an exemplary flow of processing for calculating an adjustment parameter, which is executed without using a scanner.

FIG. 13 is a flow chart illustrating an exemplary flow of processing for calculating a parameter used for correcting misregistration that may occur among MFPs, which is executed by using one sheet.

FIG. 14 illustrates an example of processing for calculating positional information about a rectangle among MFPs, which is executed by using one sheet.

### DESCRIPTION OF THE EMBODIMENTS

Various exemplary embodiments, features, and aspects of the invention will be described in detail below with reference to the drawings.

In each of the following exemplary embodiments of the present invention, a clear toner is used as a special printing material. However, a different other recording agent or toner can be used as the special printing material according to each exemplary embodiment. More specifically, a light color toner or a special color toner such as red or green toner can be used. Alternatively, a different other transparent printing material such as a transparent ink can be used.

The “clear toner” refers to a transparent printing material having a characteristic of adding a transparent image. A region of an image printed by using the clear toner only is less visible than the other regions. By using the clear toner, an image can be printed with appropriate glossiness or glaze higher than that of images printed by color toners only.

In the following description, a multifunction peripheral (MFP) is used as a printing apparatus according to each exemplary embodiment. An MFP has a plurality of functions, such as a copy function, a printer function, and a facsimile transmission function. However, the present invention is not limited to this. In other words, an apparatus capable of printing and outputting input image data can be used as the printing apparatus according to each exemplary embodiment of the present invention.

A first exemplary embodiment of the present invention will now be described below. The present exemplary embodiment, as one of exemplary embodiments of the present invention, implements a method for reducing or at least effectively correcting misregistration, which may occur between an image printed by using a first color material and another image printed by using a second color material, which are printed on the same sheet.

More specifically, in the present exemplary embodiment, a method for calculating a parameter used for correcting misregistration by scanning a chart that is output from each of an MFP (a first MFP) that uses the first color material and another MFP (a second MFP) that uses the second color material will be described.

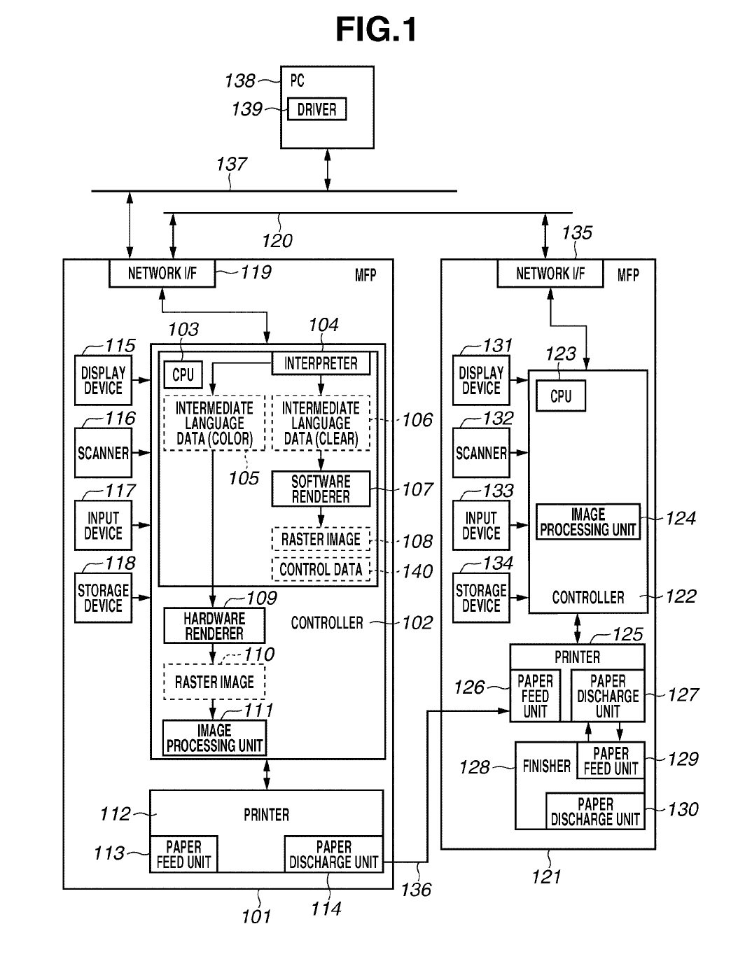

FIG. 1 illustrates an example of a system according to the present exemplary embodiment. Referring to FIG. 1, an MFP 101, which implements a first printing apparatus, and an MFP 121, which implements a second printing apparatus, are connected with each other via a network 120.

The MFP 101, which is a first MFP (hereinafter simply referred to as the “first MFP 101”), uses a first color material. More specifically, the first MFP 101 executes printing by using a color toner. The color material used by the first MFP 101 is not limited to a color toner. In other words, a monochromatic toner can be used. Similarly, the MFP 121, which is a second MFP (hereinafter simply referred to as the “second MFP 121”) , uses a second color material. More specifically, the MFP 121 executes printing by using a clear toner as a special printing material. The color material used by the second MFP 121 is not limited to the clear toner. To paraphrase this, any other special color toners can be used.

A paper discharge unit 114 of the first MFP 101 is connected to a paper feed unit 126 of the second MFP 121 via a connector 136. Accordingly, a sheet discharged from the first MFP 101 can be automatically fed to the second MFP 121.

After printing by the first MFP 101 is completed, if sheets having images printed by the first MFP 101 are serially stacked on the connector 136, in feeding a plurality of the sheets stacked on the connector 136, it becomes necessary for the second MFP 121 to serially feed the sheets one by one starting from the sheet stacked at the bottom of the stack of the printed sheets. In this case, the sheet may not be easily correctly fed. Furthermore, there may be a threat of paper jamming or misarranged printing pages.

Accordingly, the connector 136 controls paper discharge and feed timings in the above-described manner. After printing by a printer 112 of the first MFP 101 is completed, a sheet printed by using a color toner is discharged to the paper discharge unit 114. The sheet is then conveyed to the connector 136 as it is. Then, before another sheet having an image newly printed thereon by the printer 112 of the first MFP 101 is discharged to the printer 112, the second MFP 121 feeds the sheet stacked on the connector 136. Accordingly, the sheet is not stacked on the connector 136 in plurality. The sheet is conveyed from the first MFP 101 to the second MFP 121 in the above-described manner.

A PC 138 is connected with the first MFP 101 via a network 137. A driver 139 of the PC 138 recognizes the first MFP 101 and the second MFP 121 as constituting one printing system that uses the color toners and the clear toner. Accordingly, the driver 139 transmits print data to the first MFP 101 and the second MFP 121. The print data includes data necessary for generating intermediate language data and data describing the content of postprocessing (sorting, finishing, and the like) to be executed on the printed products after printing the intermediate language data. The intermediate language data will be described in detail below.

In the system illustrated in FIG. 1, a user can instruct printing that uses a color toner and printing that uses a clear toner by the same instruction.

Clear image data, which is printed by the second MFP 121, can be printed on the entire surface of the sheet. Furthermore, during print processing or copy processing, the user can designate specific color data to execute printing that uses a clear toner only for a designated region. Alternatively, the user can instruct printing that uses a clear toner that partially uses the clear toner for a specific object.

Now, the first MFP 101, which uses the color toner, will be described in detail below. A network interface (I/F) 119 receives print data and transmits a raster image and control data, which will be described in detail later below. A controller 102 includes a central processing unit (CPU) 103, a renderer 109, and an image processing unit 111.

The interpreter 104 of the CPU 103 interprets a page description language (PDL) portion of the received print data. In addition, the interpreter 104 generates intermediate language data (color) 105. The renderer 109 generates a raster image (color) 110 based on the generated intermediate language data (color) 105. The image processing unit 111 executes image processing on the raster image (color) 110 and on data of an image read by using a scanner 116.

The printer 112 is connected with the controller 102. The printer 112 is a printer that forms an image on a fed sheet based on output data by using color toners, such as cyan (C), magenta (M), yellow (Y), and black (K) toners. The printer 112 includes a paper feed unit 113 and the paper discharge unit 114. The paper feed unit 113 feeds a sheet used in printing. The paper discharge unit 114 discharges a sheet having an image of color image data formed thereon. A display device 115 displays a user interface (UI) that indicates a message to a user and status information about the first MFP 101.

The scanner 116 is a scanner including an auto document feeder (ADF). The scanner 116 irradiates an image of one or more documents with a light source (not illustrated). In addition, the scanner 116 forms an image of light reflected on the document on a solid-state image sensor. Furthermore, the scanner 116 acquires a signal read as a raster image from the solid-state image sensor. An input device 117 is an interface for receiving an input by the user. A storage device 118 stores data processed by the controller 102.

If print data input by the user includes an instruction for printing the print data by using the clear toner, the interpreter 104 generates intermediate language data (clear) 106, which is second print data, in addition to the intermediate language data (color) 105. As an example of the data format of the intermediate language data, a “name-added profile”, which is used for instructing printing that uses a clear toner for a designated specific region of image data to be printed, is used.

Processing that uses the data format will be described in detail below. When the user uses an application to associate a specific character string with a specific input color, then a name-added profile corresponding to the character string is selected. Therefore, if the user associates a specific character string with the clear toner by using the driver 139 of the PC 138, then the corresponding name-added profile is selected, and then the user is enabled to select and instruct the clear toner for a region of the image desired to be printed by using the clear toner.

The interpreter 104 generates the intermediate language data (clear) 106 by extracting only the region of the image whose printing by using the clear toner has been designated and generating a layer. The software renderer 107 converts the intermediate language data (clear) 106 into a raster image (clear) 108. The first MFP 101 transmits the raster image (clear) 108, which has been generated in the above-described manner, to the second MFP 121 via the network 120.

In the present exemplary embodiment, the name-added profile is used as the method for instructing a region of an image to be printed by using the clear toner. However, the present exemplary embodiment is not limited to this. To paraphrase this, any other methods capable of generating a raster image (clear) 108, which is instructed to be printed by using the clear toner.

In addition, the first MFP 101 transmits control data 140 to the second MFP 121 via the network 120. More specifically, the control data 140 refers to the number of sheets and information, such as the paper size, the type of the medium, and a setting for the finisher, which are set by the user via the driver 139.

Now, the second MFP 121, which uses the clear toner, will be described in detail below. A network I/F 135 is connected with the network I/F 119 via the network 120. Data communication between the first MFP 101 and the second MFP 121 can be executed via the network I/F 135.

A controller 122 includes a CPU 123 and an image processing unit 124. A printer 125 is connected with the controller 122. The printer 125 is a printer that prints an image on a sheet by using the clear toner. The printer 125 includes the paper feed unit 126, which feeds a sheet, and a paper discharge unit 127, which discharges a sheet having output data formed thereon.

The paper feed unit 126 is connected with the paper discharge unit 114 of the first MFP 101 via the connector 136. Furthermore, the paper feed unit 126 automatically feeds the sheet discharged from the first MFP 101 in the above-described manner. A finisher 128 has various functions, such as a sorting function and a stapling function.

The paper discharge unit 127 of the printer 125 is connected with the paper feed unit 129 of the finisher 128. After executing the processing designated by the user, such as sorting or stapling, the postprocessed sheet is output by using a paper discharge unit 130. A display device 131, a scanner 132, an input device 133, and a storage device 134 are similar to the display device 115, the scanner 116, the input device 117, and the storage device 118 of the first MFP 101. Accordingly, the detailed description thereof will not be repeated here.

The second MFP 121 receives the raster image (clear) 108 and the control data 140, which has been associated with the intermediate language data (color) 105, from the first MFP 101. Accordingly, color image data and clear image data to be printed on the same sheet can be associated. Furthermore, the image processing unit 124 processes the raster image (clear) 108. The printer 125 and the finisher 128 are controlled based on the control data 140.

In the above-described processing on data, the raster data (clear) is transmitted from the controller of the first MFP 101 to the controller of the second MFP 121 because the intermediate language data has been rendered within the first MFP 101. However, if the controller of the second MFP 121 includes a renderer for rendering a clear toner image, the first MFP 101 can transmit the intermediate language data (clear) to the second MFP 121 and the second MFP 121 can generate raster data (clear). In this case, the first MFP 101 does not execute rendering of the intermediate language data (clear).

If both color data and clear data are rendered within the first MFP 101, first print data is raster data (color) and second print data is raster data (clear). On the other hand, if clear data is rendered within the second MFP 121, first print data is intermediate language data (color) and second print data is intermediate language data (clear). In addition, first image data is raster data (color) and second image data is raster data (clear).

In the following description, it is supposed that clear data is rendered within the first MFP 101. Accordingly, the first print data is raster data (color) and the second print data is raster data (clear).

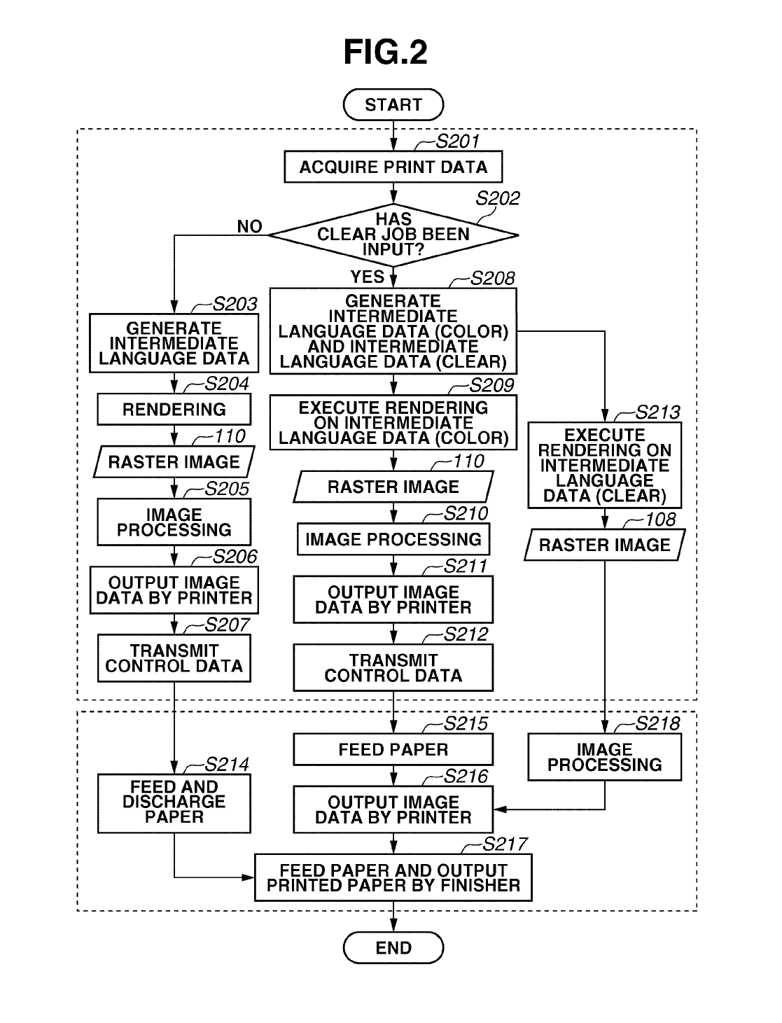

Now, an exemplary flow of print processing executed from the PC 138 via the driver 139 in the system according to an exemplary embodiment of the present invention will be described in detail below with reference to FIG. 2.

A program of processing in steps S201 through S213 is stored on the storage device 118 of the first MFP 101 and is loaded and executed by the CPU 103 on a random access memory (RAM) (not illustrated). A program of processing in steps S214 through S218 is stored on the storage device 134 of the second MFP 121 and is loaded and executed by the CPU 123 on a RAM (not illustrated).

Referring to FIG. 2, in step S201, the controller 102 acquires print data transmitted from the PC 138. As described above, in transmitting print data, the PC 138 associates a portion of the print data to be printed by using the clear toner with the name-added profile. Accordingly, the user is enabled to instruct printing using the clear toner of a specific color or a specific object.

In step 5202, the CPU 103 refers to the name-added profile included in the print data and determines whether the data has been instructed to be printed by using the clear toner (hereinafter a job like this will be simply referred to as a “clear job”).

If it is determined that the input job is not a clear job (NO in step S202) , then the processing advances to step S203. In step S203, the interpreter 104 generates the intermediate language data (color) 105. In step S204, the renderer 109 executes the rendering and generates the raster image (color) 110. In step S205, the image processing unit 111 executes image processing.

In step S206, the printer 112 outputs data generated by executing image processing on a raster image (color) by using the CMYK color toners on the sheet. In step S207, the CPU 103 transmits the control data 140 to the controller 122 of the second MFP 121 via the network I/F 119.

In step S214, the second MFP 121 refers to the control data 140 and executes paper feeding and discharge processing. In the present exemplary embodiment, the print data has been determined no to be a clear job in step S202. Accordingly, the clear toner is not to be used.

In step S217, the finisher 128 feeds and outputs the sheet based on the control data 140. If the postprocessing such as sorting has been designated by the control data 140, the finisher 128 executes the postprocessing according to the designation.

On the other hand, if it is determined that a clear job, which includes an instruction for executing printing using the clear toner is included in the input print data (YES in step S202), then the processing advances to step S208. In step S208, the interpreter 104 generates the intermediate language data (color) 105 and the intermediate language data (clear) 106.

In step S209, the renderer 109 generates the raster image (color) 110, which is the first print data, by rendering the intermediate language data (color) 105. In step S210, the image processing unit 111 executes image processing on the raster image (color) 110. In step S211, the printer 112 prints the data that has been generated by executing image processing on the raster image (color) by using the CMYK color toners on the sheet.

In step S212, the CPU 103 transmits the control data 140 to the controller 122 of the second MFP 121 via the network I/F 119. In step S213, the software renderer 107 renders the intermediate language data (clear) 106 and generates the raster image (clear) 108. In addition, the software renderer 107 transmits the generated raster image (clear) (second print data) 108 to the second MFP 121.

In step S215, the second MFP 121 refers to the control data 140 and feeds the sheets having color toner images printed thereon and having been discharged via the connector 136. In step S218, the image processing unit 124 executes image processing on the raster image (clear) 108. The image processing executed by the image processing unit 124 in step S218 is image processing necessary for generating the raster image (clear) 108 for data compliant with the performance of an engine that prints the clear toner image. More specifically, the image processing executed by the image processing unit 124 in step S218 includes screening processing.

As described above, by using the first MFP 101 and the second MFP 121 operating in the above-described manner, the present exemplary embodiment enables printing of the image printed by using the CMYK color toner and the image printed by using the clear toner on the same sheet by one instruction input via the driver 139. If the intermediate language data (clear) is transmitted to the second MFP 121, the processing in step S213 is executed by the controller 122 of the second MFP 121.

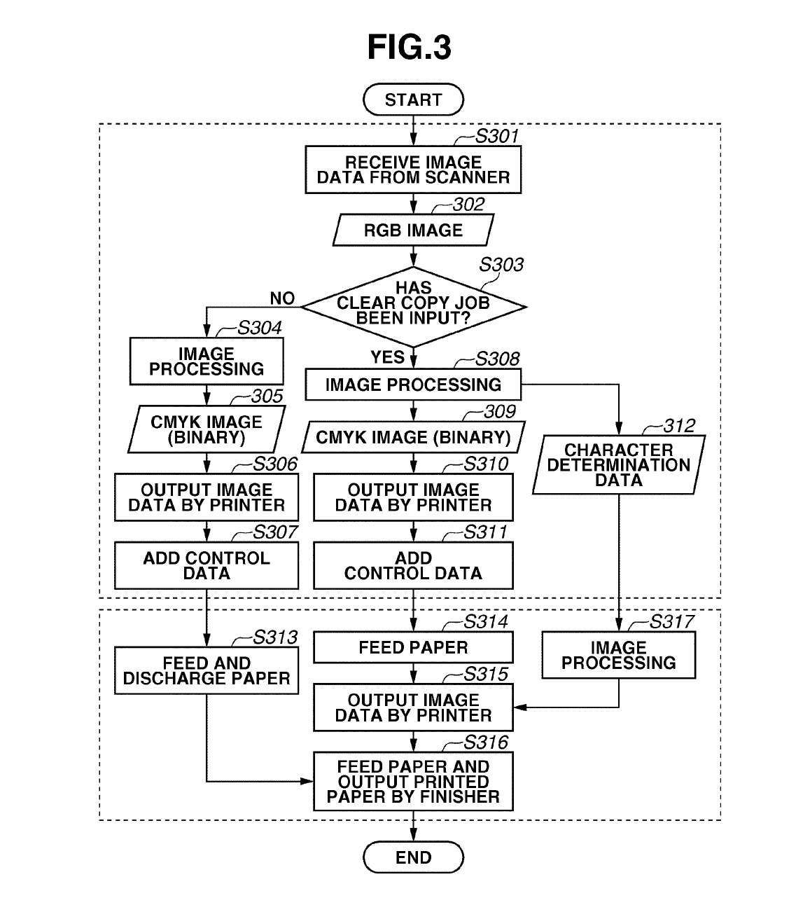

The print processing executed in the system according to the present exemplary embodiment is described above with reference to FIG. 2. Now, copy processing executed in the system according to the present exemplary embodiment will be described in detail below with reference to a flow chart of FIG. 3.

A program of processing in steps S301 through S312 is stored on the storage device 118 of the first MFP 101 and is loaded and executed by the CPU 103 on a RAM (not illustrated). A program of processing in steps S313 through S317 is stored on the storage device 134 of the second MFP 121 and is loaded and executed by the CPU 123 on a RAM (not illustrated).

Referring to FIG. 3, in step S301, the controller 102 receives an image acquired by using the scanner 116 and acquires a red (R), green (G), and blue (B) (RGB) image 302. In addition, the first controller 102 displays a copy button for instructing whether to print a clear tone image on a specific object included in the image on the display device 115 of the first MFP 101.

In step S303, the first controller 102 determines whether the copy job instructed by the user is a clear copy job for additionally applying the clear toner on the image to be copied. If it is determined that the clear toner is not to be applied to the image to be copied (NO in step S302), then the processing advances to step S304. In step S304, the image processing unit 111 executes image processing. Then, a CMYK image (binary) 305 is printed.

On the other hand, if it is determined that the input copy job is a clear copy job (YES in step S302), then the processing advances to step S308. In step S308, the image processing unit 111 executes image processing. Then, a CMYK image (binary) 309 is printed. In addition, data of a region whose printing using the clear toner has been instructed is generated during the image processing in step S308.

Suppose that a specific object existing in a document to be copied only has been instructed to be printed by the printing using the clear toner as described above. In this case, if the specific object is a text, then the CPU 103 acquires character determination data 310 based on a result of a determination on a text portion of the document. For the determination on the text portion, a publicly known method can be used. Accordingly, the description thereof is omitted in the present exemplary embodiment.

Using the text region determination data enables applying the clear toner only to the text region of the document. In the present exemplary embodiment, the character determination data is used as an example of image data for applying the clear toner to a specific object. However, the present exemplary embodiment is not limited to this. More specifically, the clear toner can be applied to an object having a specific hue extracted from objects included in the image of the document.

The first MFP 101 transmits the character determination data 310 to the second MFP 121 as raster image data for printing using the clear toner. The processing in steps S306 and S307 is similar to that in steps S206 and S207 (FIG. 2), respectively. Accordingly, the detailed description thereof will not be repeated here.

Furthermore, the processing in steps S310 and S311 is similar to that in steps S211 and S212 (FIG. 2), respectively. Accordingly, the detailed description thereof will not be repeated here either. Moreover, the processing in steps S313 through S317 is similar to that in steps S214 through S218 (FIG. 2), respectively. Accordingly, the detailed description thereof will not be repeated here.

Now, exemplary processing for printing an image without or with reduced misregistration, which is implemented by correcting misregistration that may occur between an image printed by the first MFP 101 and another image printed by the second MFP 121, which are printed on the same sheet, will be described in detail below.

In order to execute printing while preventing misregistration, the first MFP 101 executes printing by using the color toner. In addition, the first MFP 101 calculates a parameter used for correcting misregistration, such as an offset amount. Furthermore, the second MFP 121 executes printing by using the clear toner based on the calculated parameter.

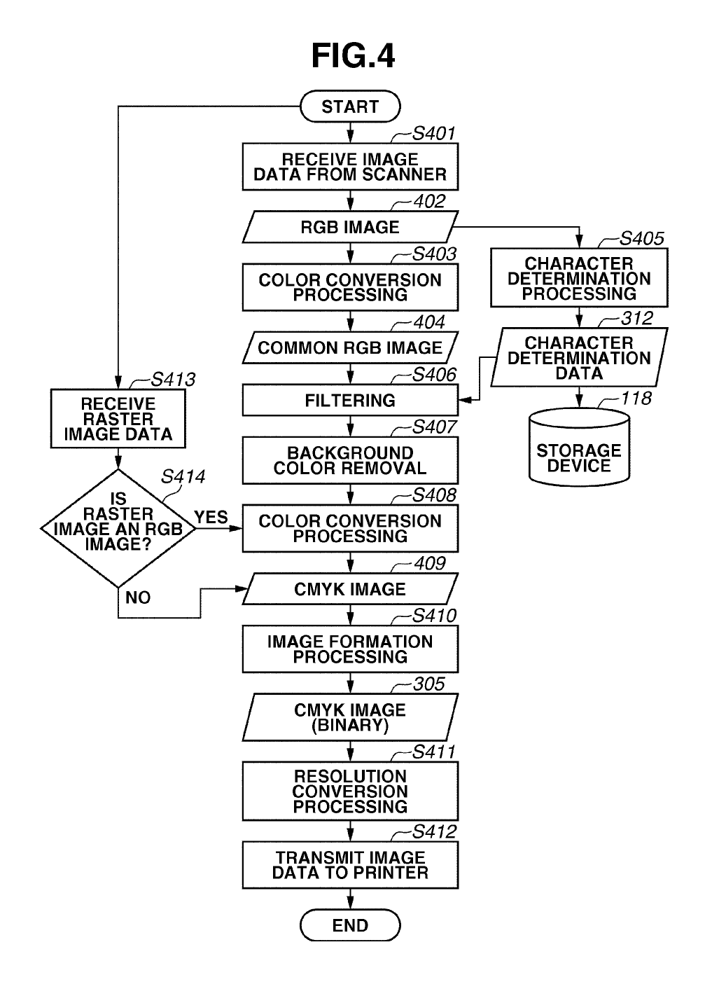

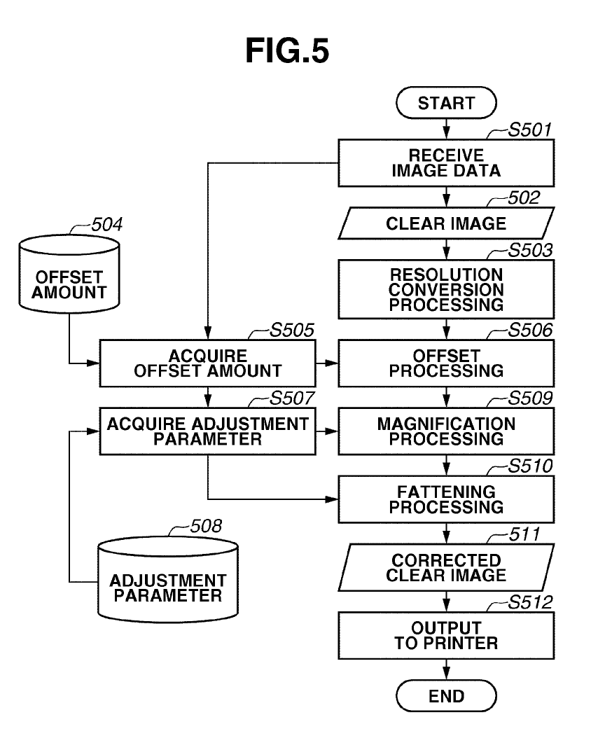

To begin with, exemplary processing executed by the image processing unit 111 of the first MFP 101 and the image processing unit 124 of the second MFP 121 will be described in detail below with reference to FIGS. 4 and 5. Processing executed by the image processing unit 111 included in the first MFP 101 will be described in detail below with reference to FIG. 4. The processing executed by the image processing unit 111 is not limited to the following processing. In other words, any appropriate processing that can implement an effect of the present invention can be executed by the image processing unit 111. Processing in steps S401 through S414 is entirely executed by the image processing unit 111.

Now, processing on image data input by the scanner 116 during copy processing will be described. Referring to FIG. 4, in step S401, the image processing unit 111 receives image data from the scanner 116 and acquires an RGB image 402. In step S403, the image processing unit 111 executes color conversion and acquires a common RGB image 404. The common RGB image is a standardized RGB image not dependent on the device. In the present exemplary embodiment, any color space not dependent on the device, such as L*a*b* color space, can be used.

In step S405, the image processing unit 111 executes character determination processing on the RGB image 402 to acquire character determination data 312. In the present exemplary embodiment, for processing on the clear image data illustrated in FIG. 3, the image processing unit 111 stores the character determination data 312 on the storage device 118.

In step S406, the image processing unit 111 executes filtering by using the character determination data 312. More specifically, the image processing unit 111 executes a high edge enhancement on a region that has been determined to include a character while executing a low edge enhancement on the other regions.

In step S407, the image processing unit 111 executes background color removal processing to remove the background color of a document. In step S408, the image processing unit 111 executes color conversion processing to generate a CMYK image 409. In step S410, the image processing unit 111 executes image formation processing to enable printing of the image by the printer 112 and generates a CMYK image (binary) 305.

If the resolution of the printer is different from the resolution of the scanner, in step S411, the image processing unit 111 executes resolution conversion. In step S412, the image processing unit 111 transmits the image data to the printer 112.

Now, processing on the raster image (color) 110, which has been transmitted from the driver 139 and generated by the renderer 109, will be described.

In step S413, the image processing unit 111 receives the raster image (color) 110. In step S414, the image processing unit 111 determines whether the raster image 110 is an RGB image. If it is determined that the raster image 110 is an RGB image, (YES in step S414), then the processing advances to step S408. In step S408, the image processing unit 111 executes color conversion and acquires the CMYK image 409.

On the other hand, if it is determined that the raster image 110 is not an RGB image (NO in step S414), then the image processing unit 111 determines that the raster image 110 is the CMYK image 409.

Now, the image processing unit 124 of the second MFP 121 will be described in detail below with reference to FIG. 5. In the example illustrated in FIG. 5, before starting printing using the clear toner, the present exemplary embodiment corrects misregistration that may occur between an image printed by the first MFP 101 and another image printed by the second MFP 121, which are printed on the same sheet. In the following description, the image printed by the first MFP 101 is referred to as a “first image” and the image printed by the second MFP 121 is referred to as a “second image”. In addition, the above-described misregistration is referred to as “misregistration that may occur between the first and the second images printed on the same sheet”. Processing in steps S501 through S512 is entirely executed by the image processing unit 124.

Referring to FIG. 5, in step S501, the image processing unit 124 receives clear image data necessary for generating a clear image 502. The clear image 502 is a raster image transmitted from the first MFP 101. In executing print processing, the raster image is the raster image (clear) 108 (FIG. 2). On the other hand, in executing copy processing, the raster image is the character determination data 312 (FIG. 3).

In step S503, the image processing unit 124 executes resolution conversion to adjust the resolution of the received clear image 502 and the resolution of the second printer 125 to be the same as each other. After receiving the image data in step S501, the processing advances to step S505. In step S505, the image processing unit 124 acquires an offset amount 504. In step S506, the image processing unit 124 executes offset processing by using the offset amount 504.

The offset processing is processing for displacing a printing position of the image data to be printed. By executing the offset processing, misregistration between the first and the second images printed on the same sheet can be corrected although only partially. The method for calculating the offset amount 504 will be described in detail below.

In step S507, the image processing unit 124 acquires an adjustment parameter 508. In step S509, the image processing unit 124 executes magnification processing by using the adjustment parameter 508. In step S510, the image processing unit 124 executes fattening processing also by using the adjustment parameter 508 and generates a corrected clear image 511.

By executing the above-described processing, the present exemplary embodiment can effectively correct misregistration that may occur between the first and the second images printed on the same sheet, which has not been entirely corrected by the offset processing by using the adjustment parameter 508. The method for calculating the adjustment parameter 508 will be described in detail below. In step S512, the image processing unit 124 prints the corrected clear image 511 by using the printer 125.

As described above, the present exemplary embodiment executes the offset processing, the magnification processing, and the boldface processing to correct misregistration that may occur between the first and the second images printed on the same sheet. However, the present exemplary embodiment is not limited to this. More specifically, any method that can implement the effect of the present invention for correcting the misregistration can be employed.

Alternatively, the present exemplary embodiment can execute the offset processing only to correct the misregistration. Further alternatively, in order to correct the misregistration, the present exemplary embodiment can execute an arbitrary combination of the offset processing and the magnification processing or the fattening processing. Therefore, yet further alternatively, the processing in steps S509 and S510 can be omitted.

As described above, in the present exemplary embodiment, the offset amount 504 and the adjustment parameter 508 are used as a parameter used for correcting misregistration that may occur between the first and the second images printed on the same sheet. However, the parameter used in the present exemplary embodiment is not limited to these. More specifically, any other parameters that can implement the effect of the present invention can be used instead.

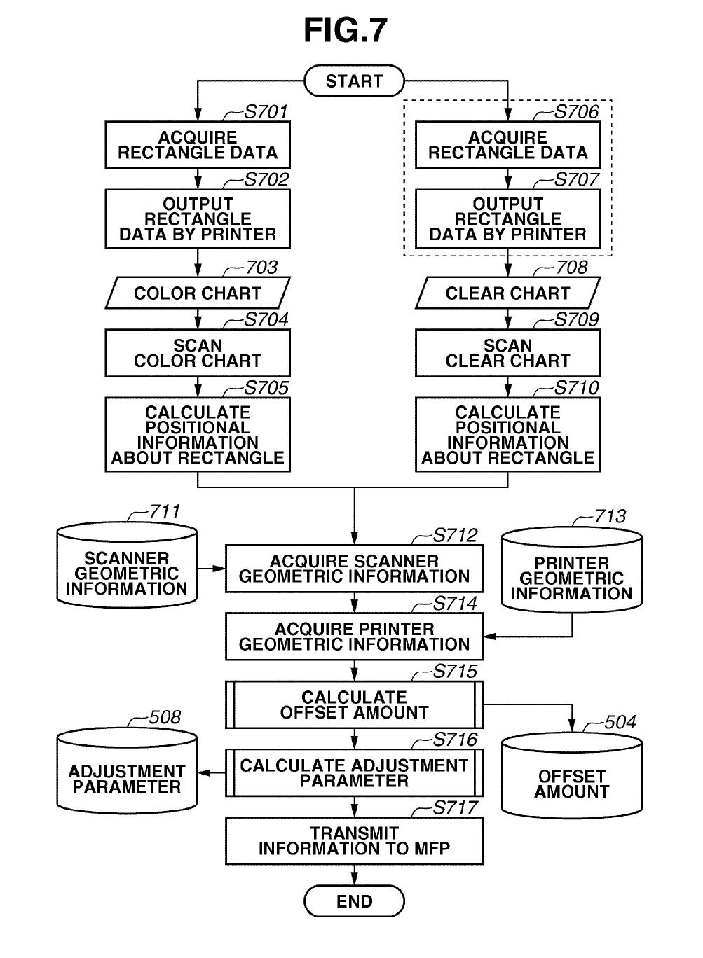

Now, processing for calculating the parameter (offset amount) used for correcting the misregistration that may occur between the first and the second images printed on the same sheet will be described in detail below with reference to FIG. 7. A program of processing in steps S706 and S707, of processing in steps S701 through S717, is previously stored on the storage device 134 of the second MFP 121. The program is loaded and executed by the CPU 123 on a RAM (not illustrated). Another program of processing of steps other than steps S706 and S707 is stored on the storage device 118 of the first MFP 101. The program of processing of steps other than steps S706 and S707 is loaded and executed by the CPU 103 on the RAM (not illustrated).

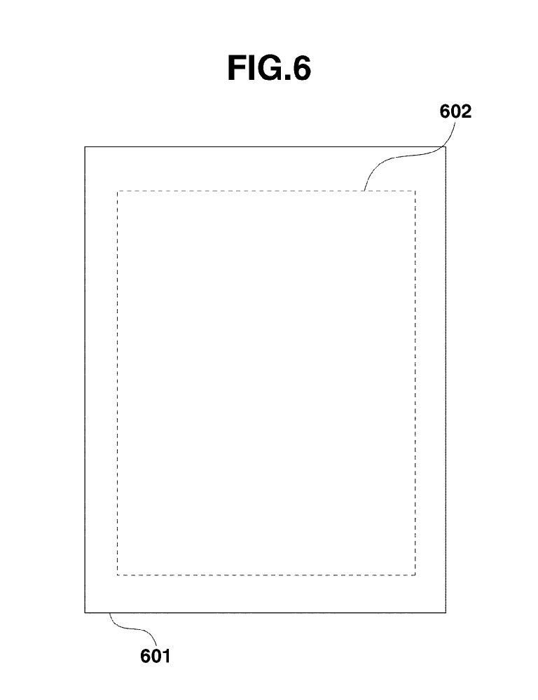

Referring to FIG. 7, in step S701, the controller 102 of the first MFP 101 acquires rectangle data from the storage device 118. FIG. 6 illustrates an example of the rectangle data. In addition, in step S701, the first controller 102 executes control for generating rectangle data 602, whose size of the rectangle is smaller than the size of a sheet 601. The shape of the data 602 is not limited to a rectangle. In other words, the data 602 can take any appropriate shape if positional information about the data 602 can be identified.

In step S702, the printer 112 of the first MFP 101 prints the rectangle data and generates a color chart 703, which is a first chart. Furthermore, the user sets the sheet having the color chart 703 generated and printed thereon on the scanner 116 of the first MFP 101. In step 5704, the scanner 116 scans the color chart 703.

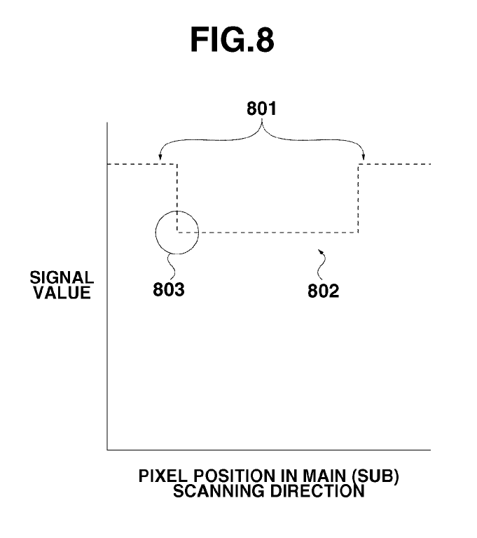

In step S705, the controller 102 of the first MFP 101 calculates the positional information about the rectangle based on the acquired image data. An exemplary method for acquiring the positional information about the rectangle will be described in detail below with reference to FIG. 8.

In the graph illustrated in FIG. 8, a signal value is taken on the vertical axis. A pixel position of image data in the main scanning direction or in the sub scanning direction is taken on the horizontal axis. The greater the signal value becomes, the higher the brightness of the corresponding dot becomes. In other words, the smaller the signal value becomes, the lower the brightness of the corresponding dot becomes.

Referring to FIG. 8, a signal value 801 is a value acquired by executing reading on a region of the sheet having no toner applied. A signal value 802 is a value acquired by executing reading on a rectangular region of the sheet on which a toner has been applied.

In the present exemplary embodiment, the color chart has the rectangular shape. Accordingly, if reading is executed in the main scanning direction or in the sub scanning direction, substantially the same signal value 802 can be acquired at any reading positions.

At a portion 803, the signal value of the sheet is switched to the signal value of the rectangular region. By extracting the portion 803, the present exemplary embodiment can calculate the pixel position of the position at which the reading enters the rectangular region. By executing the above-described processing in the main scanning direction and in the sub scanning direction of the image data, the present exemplary embodiment can calculate the positional information about the rectangle.

In step S706, the controller 122 of the second MFP 121 acquires rectangle data from the storage device 134 of the second MFP 121. In step S707, the second printer 125 of the second MFP 121 prints the same rectangle data. In addition, the second controller 122 generates a clear chart 708, which is a second chart having been printed by using the clear toner. The user sets the generated clear chart 708 on the scanner 116 of the first MFP 101.

In step S709, the scanner 116 of the first MFP 101 scans the clear chart 708. Because the clear chart 708 has been printed by using the clear toner, the signal value of the rectangle becomes closer to the signal value read from the sheet itself compared to a color chart printed by using the color toner. Accordingly, the difference between the signal value read from the sheet and the signal value read from the rectangle can be increased by scanning the image data with light from the light source having a lower brightness compared to the brightness of light used in normal scanning operations.

In addition, similarly to the processing for scanning the color chart 703, the clear chart 708 can be scanned by the scanner 116 of the first MFP 101 to reduce the difference of geometric information, which may arise due to an individual difference between scanners. Alternatively, the clear chart 708 can be scanned by the scanner 132 of the second MFP 121. In this case, data acquired by the scanning can be transmitted to the first controller 102 of the first MFP 101.

In step S710, the controller 102 of the first MFP 101 calculates the positional information about the rectangle included in the clear chart 708. In step S712, the controller 102 of the first MFP 101 acquires scanner geometric information 711 from the storage device 118 of the first MFP 101. The scanner geometric information 711 is the device characteristic of the scanner. More specifically, the scanner geometric information 711 includes information about scanning, such as characteristic information including the resolution, information about the accuracy of registration (an image forming position) during scanning by using an ADF, and information about the misregistration of the chart set on a document mounting plate of the ADF. Furthermore, the scanner geometric information 711 is information dependent on the scanner 116, which is previously stored on the storage device 118 of the image processing unit 111.

In step S714, the controller 102 of the first MFP 101 acquires geometric information 713 about the printer 125 of the second MFP 121 from the storage device 118 of the first MFP 101. The geometric information 713 about the printer is a device characteristic of the printer. More specifically, the geometric information 713 includes characteristic information about the second printer 125 of the second MFP 121, such as the resolution, and information about the accuracy of registration of the second printer 125. Furthermore, the geometric information 713 is information dependent on the second printer 125, which is previously stored on the storage device 134 of the second MFP 121.

On the printer 125, if the same image data is printed more than once, the registration position of the sheet (chart) may deviate from the registration position of the first operation. In other words, in this case, the image data may be printed at different positions during a plurality of printing operations. In other words, the information about the accuracy of registration (hereinafter simply referred to as “registration accuracy information”) describes the degree of the misregistration (misregistration) in numerical values. In the present exemplary embodiment, each geometric information is expressed by a numerical value. However, the geometric information can be expressed in any appropriate unit, such as the pixel value or the actual magnitude (length or width) of the misregistration.

In step S715, the controller 102 of the first MFP 101 calculates the offset amount 504. In step S716, the controller 102 of the first MFP 101 calculates the adjustment parameter 508. Methods for calculating the offset amount 504 and the adjustment parameter 508 will be described in detail below. In step S717, the controller 102 transmits the information, such as the offset amount 504 and the adjustment parameter 508, to the second MFP 121.

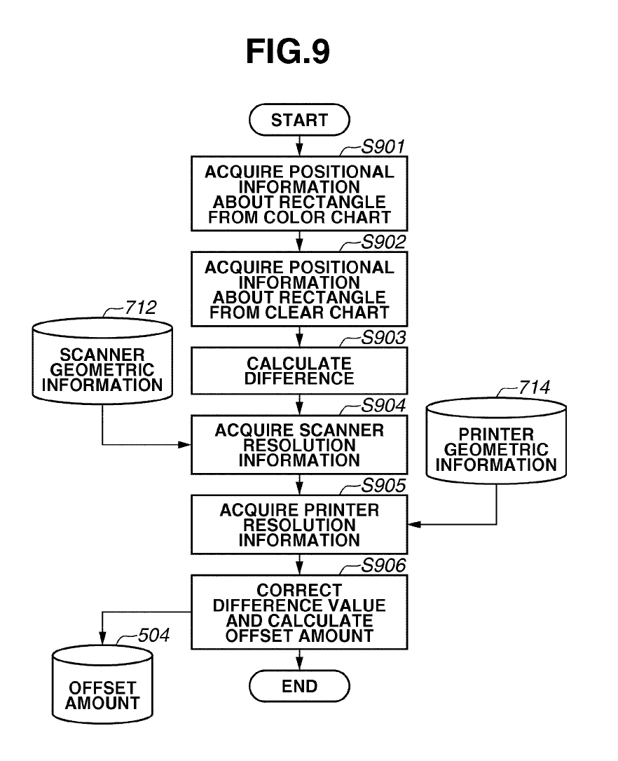

Processing for calculating the offset amount will be described in detail below with reference to FIG. 9. Referring to FIG. 9, in step S901, the controller 102 of the first MFP 101 acquires the positional information about the rectangle included in the color chart 703. In step S902, the first controller 102 acquires the positional information about the rectangle included in the clear chart 708.

In step S903, the controller 102 of the first MFP 101 calculates the difference between the positional information about the rectangles included in the color chart 703 and the clear chart 708. The positional information about the rectangle is described based on the pixel position illustrated in FIG. 8. Accordingly, the difference between the positions of the scanned rectangles can be calculated based on the difference between the pixel positions.

In step S904, the controller 102 acquires resolution information about the scanner 116 from scanner geometric information 712. In step S905, the controller 102 acquires resolution information about the printer 125 from the geometric information 714 about the printer. In step S906, the controller 102 corrects the difference value by using the resolution information. In addition, the first controller 102 calculates the offset amount 504.

The resolution of the scanner may be different from the resolution of the printer. Accordingly, if the difference calculated based on the resolution of the scanner is applied as it is in calculating the offset amount for the printer 125, the difference value may not be appropriately corrected. Accordingly, the present exemplary embodiment executes the above-described processing.

More specifically, suppose that the resolution of the scanner 116 is 600 dots per inch (dpi) and the resolution of the second printer 125 is 1,200 dpi. In this case, the first controller 102 of the first MFP 101 corrects the difference value by doubling the difference value. Furthermore, the first controller 102 transmits the calculated offset amount 504 to the second controller 122 of the second MFP 121.

Furthermore, the received value is applied in the offset processing executed by the image processing unit 124 in step S506 (FIG. 5). By executing the above-described processing, the positions of starting the registration on the printer 112 of the first MFP 101 and the second printer 125 of the second MFP 121 can be adjusted to the same position.

However, due to the possible influence from the accuracy of scanning by the scanner 116 and the accuracy of registration of the second printer 125 of the second MFP 121, misregistration that may occur between the first and the second images printed on the same sheet may still occur if the above-described offset processing is executed. In order to correct the still possibly remaining misregistration, the present exemplary embodiment calculates the adjustment parameter 508.

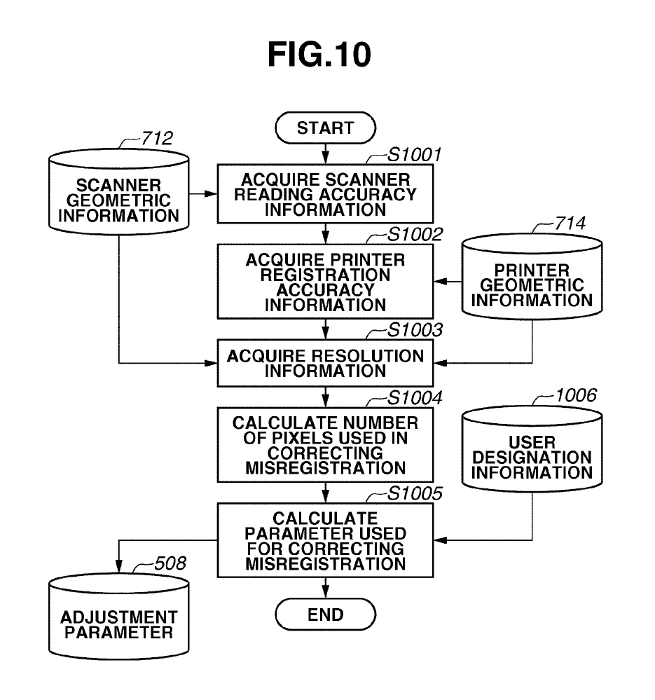

Exemplary processing for calculating the adjustment parameter 508 according to the present exemplary embodiment will be described in detail below with reference to FIG. 10. Referring to FIG. 10, in step S1001, the controller 102 of the first MFP 101 acquires scanner reading accuracy information from the scanner geometric information 712.

The scanner reading accuracy information includes various information, such as the accuracy of registration when the document is fed and scanned by using the ADF of the scanner 116 of the first MFP 101 and information about misregistration of the chart set on the document mounting plate. The scanner reading accuracy information is expressed by using a pixel value.

If a plurality of sheets is scanned, the sheets may be read at different positions (i.e., misregistration may occur). Accordingly, in reading a plurality of sheets, it is necessary to correct the misregistration that may occur due to the influence from the reading (scanning) accuracy.

In step S1002, the controller 102 of the first MFP 101 acquires the printer registration accuracy information from the geometric information 714 about the printer. The printer registration accuracy information includes registration information about the printer 125 of the second MFP 121 and is expressed by using the pixel value. The unit of expressing the accuracy information is not limited to the pixel value. In other words, the accuracy information can be expressed by the physical unit of length or width, such as millimeter.

In step S1003, the controller 102 of the first MFP 101 acquires the resolution information about the scanner 116 of the first MFP 101 and the resolution information about the second printer 125 of the second MFP 121 from the scanner geometric information 712 and the geometric information 714, respectively. In step S1004, the controller 102 of the first MFP 101 calculates the number of pixels used for correcting the misregistration by using the accuracy information and the resolution information.

More specifically, if the acquired accuracy information is expressed by the pixel value and if the resolution of the scanner is 600 dpi and the resolution of the printer is 1,200 dpi, then the first controller 102 doubles the scanner reading accuracy information to convert the same to “1,200 dpi”. Furthermore, the first controller 102 adds the converted scanner reading accuracy information to the printer registration accuracy information.

In step S1005, the controller 102 of the first MFP 101 calculates a parameter used for correcting misregistration (hereinafter simply referred to as a “misregistration correction parameter”) based on the calculated number of pixels used for correcting the misregistration and user designation information 1006. Furthermore, the first controller 102 stores the calculated misregistration correction parameter as the adjustment parameter 508. The user designation information 1006 includes the number of pixels designated by the user.

For a special color toner image, such as a clear toner image, it may be only significant whether the clear toner image has been printed in overlap with a color toner image. In this case, it may not be necessary that the clear toner image is printed in overlap with the color toner image with a high registration accuracy. Accordingly, in this case, the range of positions of printing the image data printed by using the clear toner can be extended to a sufficiently wide range. The user can designate the number of pixels included in the extended range.

Furthermore, the first controller 102 of the first MFP 101 transmits the calculated adjustment parameter 508 to the second controller 122 of the second MFP 121. The calculated value is applied to the magnification processing and the fattening processing executed by the image processing unit 124 of the second MFP 121 (FIG. 5). Accordingly, the misregistration still remaining after the offset processing can be effectively corrected.

An exemplary method for applying the adjustment parameter 508 will be described below. If the number of pixels used for correcting the misregistration, which includes the number of pixels included in the user designation information, is 3.5 pixels, three pixels, which is described by the integer part “3”, are generated by executing the fattening processing. On the other hand, 0.5 pixels, which is described by the decimal fraction, is generated by executing the magnification processing, which is executed based on a magnification ratio that can be appropriately set. However, the adjustment can be executed by performing either one of the magnification processing and the fattening processing.

In the present exemplary embodiment, the first MFP 101 calculates the offset amount and the adjustment parameter amount, which are correction values, and transmits the calculated correction values to the second MFP 121. In addition, in executing the printing that uses the clear toner, the second MFP 121 executes printing by using and applying the received correction values. Furthermore, the first controller 102 and the scanner 116 of the first MFP 101 execute the processing other than the processing in steps S706 and S707. However, alternatively, the second controller 122 and the scanner 132 of the second MFP 121 can execute the processing other than the processing in steps S706 and S707 instead of the first controller 102 and the scanner 116 of the first MFP 101.

In this case, the processing in steps S701 and S702 only is executed by the first MFP 101. In addition, in this case, the second controller 122 of the second MFP 121 acquires the scanner reading accuracy information about the scanner 132. In other words, in this case, in executing the printing that uses the clear toner, the second MFP 121 can calculate the correction value and can apply the calculated correction value to the printing.

With the above-described configuration, the present exemplary embodiment can effectively correct misregistration that may occur between the first and the second images printed on the same sheet, which may occur in the system including a plurality of mutually-connected MFPs. In particular, because the present exemplary embodiment having the above-described configuration can automatically adjust the correction amount by using the scanner, the present exemplary embodiment is capable of effectively correcting the misregistration even if it is necessary to correct the misregistration very frequently.

Now, a second exemplary embodiment of the present invention will be described in detail below. The present exemplary embodiment calculates a parameter for correcting misregistration that may occur between the first and the second images printed on the same sheet that may occur in the system including a plurality of mutually-connected MFPs without using the scanner.

In the above-described first exemplary embodiment, in order to correct the misregistration, each printer prints the chart and the scanner 116 generates color image data. Furthermore, the above-described first exemplary embodiment generates and uses the offset amount 504 and the adjustment parameter 508 in correcting the misregistration.

In the present exemplary embodiment, the scanner 116 is not used. More specifically, the present exemplary embodiment calculates a parameter used for correcting the misregistration that may occur between the first and the second images printed on the same sheet based on a user input received via the display device 115 and the input device 117.

In the above-described first exemplary embodiment, the printing system includes an MFP and uses the MFP to correct the misregistration. However, if a user desires to print image data but does not desire to execute copy processing of the image data, the user does not need to use the scanner 116. In an environment of use of the printing system by the above-described user, the printing system may not include the scanner 116. In this environment, no scanner can be utilized for correcting the misregistration that may occur between the first and the second images printed on the same sheet. The present exemplary embodiment can be applied and is useful in this case. In addition, if the printing system includes the scanner 116 but the scanner 116 is not currently available due to malfunction, i.e., if the correction of the misregistration by using the scanner is not available, the present exemplary embodiment can be applied and useful.

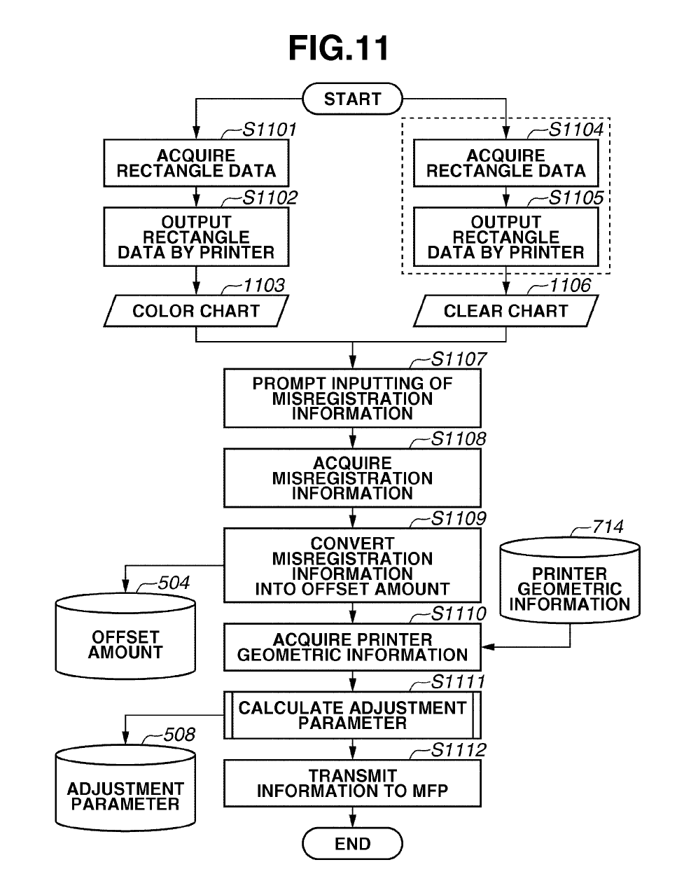

FIG. 11 is a flow chart illustrating an exemplary flow of processing executed by the present exemplary embodiment. A program of processing in steps S1104 and S1105, of processing in steps S1101 through S1112, is previously stored on the storage device 134 of the second MFP 121. The program is loaded and executed by the CPU 123 on a RAM (not illustrated). Another program of processing of steps other than steps S1104 and S1105 is stored on the storage device 118 of the first MFP 101. The program of processing of steps other than steps S1104 and S1105 is loaded and executed by the CPU 103 on the RAM (not illustrated).

Processing in steps S1101 and S1102 for generating a color chart 1103 is the same as the processing in steps S701 and S702 (FIG. 7). Accordingly, the detailed description thereof will not be repeated here. In addition, processing in steps S1104 and S1105 for generating a clear chart 1106 is the same as the processing in steps S706 and S707 (FIG. 7). Accordingly, the detailed description thereof will not be repeated here.

Referring to FIG. 11, in step S1107, the display device 115 of the first MFP 101 displays a message that prompts the user to input information about the position of scanning (reading) on the color chart 1103 and the clear chart 1106 in the main scanning direction and in the sub scanning direction. In step S1108, the input device 117 receives a user input of the amount of the misregistration that has occurred between the first and the second images printed on the same sheet. The amount of the misregistration that has occurred between the first and the second images printed on the same sheet can be acquired by measurement executed by the user. In the above-described manner, information about misregistration can be acquired. The information about misregistration can be expressed by any appropriate unit.

In step S1109, the controller 102 of the first MFP 101 converts the acquired misregistration information into the offset amount 504. More specifically, the acquired offset information is described in a physical unit of length, such as millimeter or inch. Furthermore, the first controller 102 converts the acquired offset information into the number of pixels compliant with the resolution of the printer.

In step S1110, the controller 102 of the first MFP 101 acquires the geometric information 714 about the printer of the second MFP 121. In step S1111, the controller 102 of the first MFP 101 calculates the adjustment parameter 508. In step S1112, the controller 102 of the first MFP 101 transmits the calculated information to the second MFP 121.

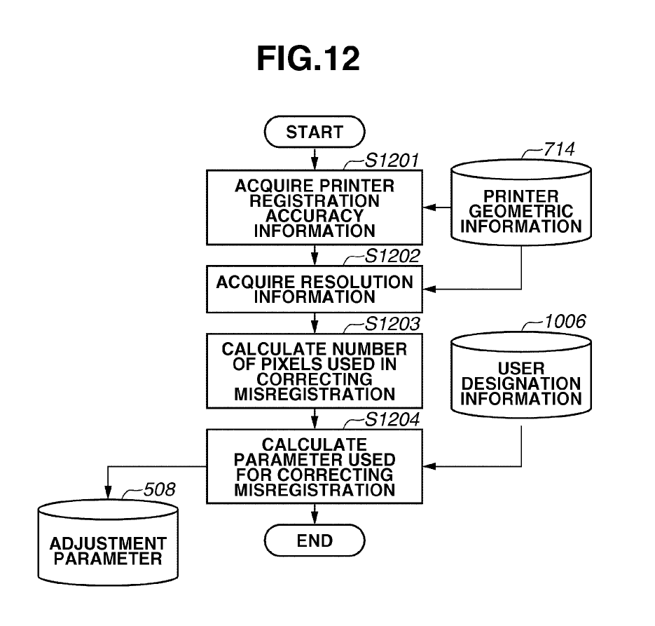

FIG. 12 is a flow chart illustrating an exemplary flow of the processing in step S1111 for calculating the adjustment parameter. In the present exemplary embodiment, unlike the first exemplary embodiment, the first MFP 101 does not include the scanner 116. Accordingly, the present exemplary embodiment is different from the first exemplary embodiment in a point that the present exemplary embodiment does not acquire or use scanner reading accuracy information.

Referring to FIG. 12, in step S1201, the controller 102 of the first MFP 101 acquires the printer registration accuracy information from the geometric information 714 about the printer. In step S1202, the controller 102 of the first MFP 101 acquires the resolution information about the printer 125 of the second MFP 121 from the geometric information 714 about the printer.

In step S1203, the controller 102 of the first MFP 101 calculates the number of pixels used for correcting the misregistration by using the accuracy information and the resolution information. In step S1204, the controller 102 of the first MFP 101 calculates the misregistration correction parameter based on the number of pixels used for correcting the misregistration calculated in step S1203 and the user designation information 1006. Moreover, the first controller 102 stores the calculated misregistration correction parameter as the adjustment parameter 508.

As described above, the first controller 102 transmits the acquired information to the second MFP 121. After receiving the information from the first controller 102 of the first MFP 101, the second MFP 121 applies the received correction value, such as the offset amount and the adjustment parameter, to the printing executed by the second MFP 121.

With the above-described configuration, the present exemplary embodiment can effectively correct the misregistration that may occur between the first and the second images printed on the same sheet, which may occur in the system including a plurality of mutually-connected MFPs. In particular, the present exemplary embodiment having the above-described configuration can effectively correct the misregistration even in an environment in which no scanner is available.

Now, a third exemplary embodiment of the present invention will be described in detail below. The present exemplary embodiment calculates a parameter used for correcting the misregistration that may occur between the first and the second images printed on the same sheet, which may occur in the system including a plurality of mutually-connected MFPs, by using one chart only.

In each of the above-described exemplary embodiments of the present invention, each of the printer 112 of the first MFP 101 and the second printer 125 of the second MFP 121 generates the chart used for correcting the misregistration. The present exemplary embodiment generates a chart for one sheet by using the printer 112 of the first MFP 101 and the second printer 125 of the second MFP 121 and calculates a parameter used for correcting the misregistration based on the generated chart.

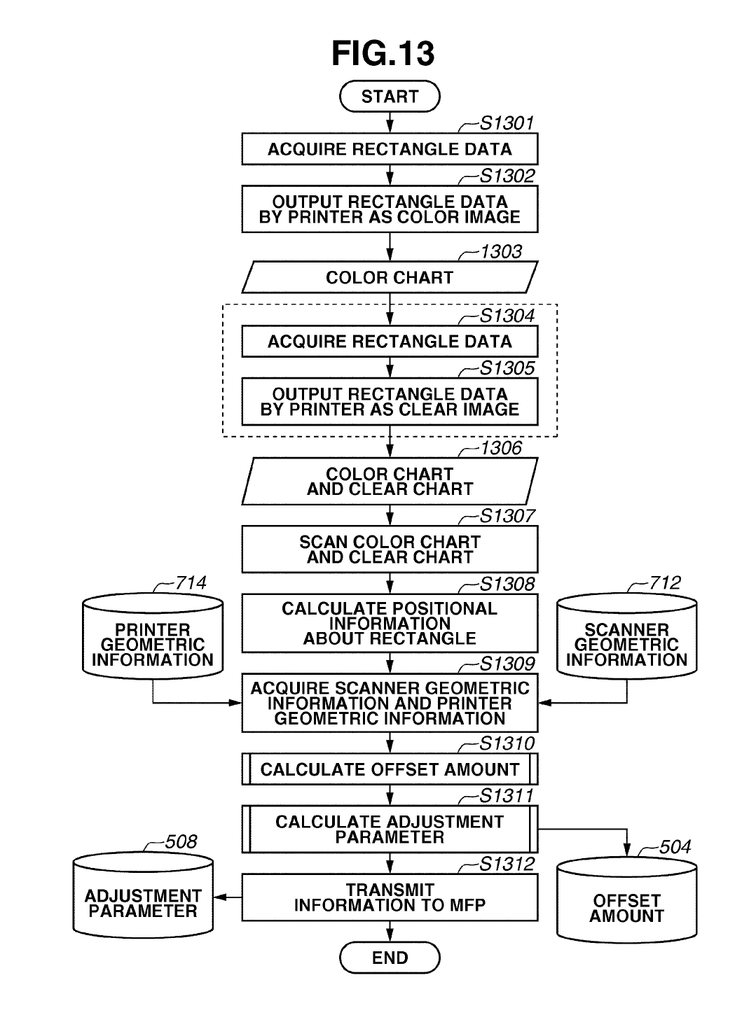

FIG. 13 is a flow chart illustrating an exemplary flow of processing executed by the present exemplary embodiment. A program of processing in steps S1304 and S1305, of processing in steps S1301 through S1312, is previously stored on the storage device 134 of the second MFP 121. The program is loaded and executed by the CPU 123 on a RAM (not illustrated). Another program of processing of steps other than steps S1304 and S1305 is stored on the storage device 118 of the first MFP 101. The program of processing of steps other than steps S1304 and S1305 is loaded and executed by the CPU 103 on the RAM (not illustrated).

Processing in steps S1301 and S1302 for generating a color chart 1303 is the same as the processing in steps S701 and S702 (FIG. 7). Accordingly, the detailed description thereof will not be repeated here. In step S1304, the controller 122 of the second MFP 121 acquires rectangle data. In step S1305, the paper feed unit 126 of the printer 125 feeds the printed color chart 1303 from the paper discharge unit 114 of the printer 112 of the first MFP 101. In addition, the second printer 125 of the second MFP 121 prints the rectangle data on the sheet by using the clear toner. Furthermore, the second printer 125 generates a color/clear chart 1306.

In step S1307, the scanner 116 of the first MFP 101 scans the color/clear chart 1306 and acquires image data. In step S1308, the controller 102 of the first MFP 101 calculating the rectangle reading position information.

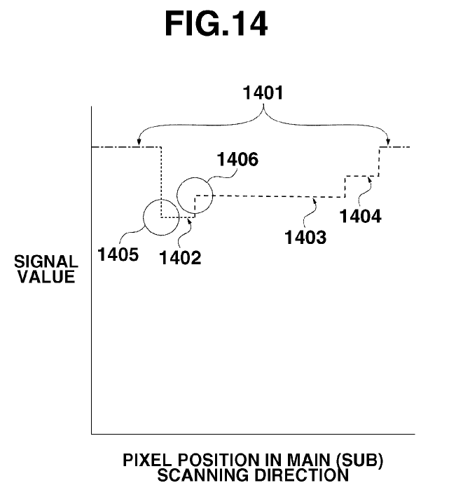

An exemplary method for calculating the rectangle reading position information will be described in detail below with reference to FIG. 14. In the graph illustrated in FIG. 14, the signal value is taken on the vertical axis. The pixel position of the image data in the main scanning direction or in the sub scanning direction is taken on the horizontal axis. The greater the signal value becomes, the higher the brightness of the corresponding dot becomes. In other words, the smaller the signal value becomes, the lower the brightness of the corresponding dot becomes.

A signal value 1401 is acquired by scanning (reading) the sheet. The color/clear chart 1306 has a color image printed thereon by the printer 112 of the first MFP 101 and a clear image printed thereon by the second printer 125 of the second MFP 121. If no misregistration has occurred on the color/clear chart 1306, even signal values can be acquired by scanning the color/clear chart 1306.

On the other hand, if any misregistration has occurred on the color/clear chart 1306, three types of signal values can be acquired. More specifically, a signal value corresponding to the region of the image data printed by using the color toner only, a signal value corresponding to the region of the image data printed by using the clear toner only, and a signal value corresponding to the region of the image data printed by using both the color and the clear toners can be acquired.

In the example illustrated in FIG. 14, a region 1402 is printed by using the color toner only. The signal value corresponding to the region 1402 is the “darkest” (i.e., the lowest) of the three types of signal values. Furthermore, a region 1403 is printed by using both the color and the clear toners. The signal value corresponding to the region 1403 is “brighter” (i.e., higher) than the signal value corresponding to the region printed by using the color toner only.

Moreover, a region 1404 is printed by using the clear toner only. The signal value corresponding to the region 1404 is the “brightest” (i.e., the highest) of the three types of signals except the signal value corresponding to the sheet itself. At a portion 1405, the signal value 1401 corresponding to the sheet itself is changed to the signal value 1402 corresponding to the region printed by using the color toner only. At a portion 1406, the signal value 1402 corresponding to the region printed by using the color toner only is changed to the signal value 1403 corresponding to the region printed by using both the color and the clear toners.

The present exemplary embodiment can acquire the position of the rectangle data printed by the printer 112 and the position of the rectangle data printed by the second printer 125 based on the pixel positions 1405 and 1406 and the signal values 1402 and 1403.

Processing in steps S1309, S1310, and S1312 is the same as the processing in steps S714, S715, and S717 illustrated in FIG. 7. Accordingly, the detailed description thereof will not be repeated here. In addition, processing in step S1311 is similar to the processing in step S1111 illustrated in FIG. 11. Accordingly, the detailed description thereof will not be repeated here.

As described above, the present exemplary embodiment prints the data about the printer 112 and the second printer 125 on one sheet. Accordingly, the present exemplary embodiment does not need to execute the scanning very frequently. Therefore, it is not necessary for the present exemplary embodiment to use the scanner reading accuracy information. Accordingly, the present exemplary embodiment does not need to acquire scanner reading accuracy information in calculating the adjustment parameter.

As described above, in the present exemplary embodiment, the scanner 116 of the first MFP 101 is used. However, the present exemplary embodiment is not limited to this. More specifically, the present exemplary embodiment can calculate the parameter used for correcting the misregistration that may occur between the first and the second images printed on the same sheet by using the information input by the user in an environment in which no scanner is available as in the second exemplary embodiment described above. Alternatively, instead of the above-described configuration, the second MFP 121 can execute the scanning and calculate the correction value to be applied to the printing.

With the above-described configuration, the present exemplary embodiment can effectively correct misregistration that may occur between the first and the second images printed on the same sheet, which may occur in the system including a plurality of mutually-connected MFPs. In particular, as described above, the present exemplary embodiment outputs the chart printed by using the plurality of MFPs on one sheet. Accordingly, the present exemplary embodiment having the above-described configuration can effectively save the number of sheets to be printed and reduce the time required for scanning at the same time.

In addition, it is highly likely that the present exemplary embodiment does not need to acquire or use the scanner reading accuracy information. Therefore, it becomes necessary for the present exemplary embodiment to merely acquire and use the printer geometric information only in calculating the parameter for correcting the above-described misregistration. Accordingly, the present exemplary embodiment having the above-described configuration can calculate the parameter with a sufficiently high accuracy.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-297378 filed Dec. 28, 2009, which is hereby incorporated by reference herein in its entirety.

What is claimed is:

1. A printing system including a first printing apparatus configured to execute printing by using a first color material and a second printing apparatus configured to execute printing by using a second color material, a paper discharge portion of the first printing apparatus and a paper feed portion of the second printing apparatus being connected to each other,
wherein the first printing apparatus comprises:
a generation unit configured to generate first print data and second print data based on input print data;
a transmission unit configured to transmit the second print data to the second printing apparatus; and
a paper discharge unit configured to print the first print data on a sheet by using the first color material and to discharge the printed sheet from the paper discharge portion, and
wherein the second printing apparatus comprises:
an acquisition unit configured, in printing the second print data received from the first printing apparatus, to acquire a correction parameter used for correcting a position of printing the second print data to reduce misregistration that may occur on the sheet;
a correction unit configured to correct a position of printing the second print data by using the correction parameter acquired by the acquisition unit; and
a printing unit configured to print the second print data, which has been corrected by the correction unit, on the sheet having the first print data printed thereon by using the second color material.

2. The printing system according to claim 1, wherein the correction parameter is calculated based on positional information acquired from a first chart printed by the first printing apparatus and a second chart printed by the second printing apparatus, a device characteristic of a scanner included in the first printing apparatus, and a device characteristic of a printer included in the second printing apparatus.

3. The printing system according to claim 2, wherein the device characteristic includes resolution information and accuracy information about each of the scanner and the printer.

4. The printing system according to claim 2, wherein the positional information is acquired from a signal value corresponding to each pixel acquired by scanning the first chart and a signal value corresponding to each pixel acquired by scanning the second chart.

5. The printing system according to claim 2, further comprising an input unit configured to receive an input of the positional information, which is input by a user to acquire the positional information.

6. The printing system according to claim 1, wherein the correction unit is configured to execute offset processing.

7. The printing system according to claim 1, wherein the correction unit is configured to execute magnification processing and/or fattening processing in addition to offset processing.

8. The printing system according to claim 1, wherein the first color material is one of or a combination of a cyan color toner, a magenta color toner, a yellow color toner, and a black color toner, and
wherein the second color material is a clear toner.

9. A printing apparatus comprising:
a generation unit configured to generate first print data and second print data based on input print data;
a printing unit configured to print the first print data generated by the generation unit on a sheet;
an acquisition unit configured, in order to print the second print data on the sheet having the first print data printed thereon by the printing unit while reducing misregistration, to acquire a correction parameter used for correcting a position of printing the second print data;
a transmission unit configured to transmit the second print data generated by the generation unit and the correction parameter acquired by the acquisition unit to a second printing apparatus; and
a conveyance unit configured to convey the sheet having the first print data printed by the printing unit to a paper feed unit of the second printing apparatus.

10. The printing apparatus according to claim 9, further comprising a reception unit configured to receive a device characteristic of the second printing apparatus from the second printing apparatus to acquire the correction parameter.

11. A printing apparatus comprising:
a generation unit configured to generate first print data and second print data based on input print data;
an acquisition unit configured to acquire a correction parameter used for correcting a position of printing the first print data;
a transmission unit configured to transmit the first print data generated by the generation unit and the correction parameter acquired by the acquisition unit to a second printing apparatus;
a paper feed unit configured to feed a sheet having the first print data printed thereon by the second printing apparatus, the position of printing of the first print data being corrected by using the correction parameter; and
a printing unit configured to print the second print data on the sheet fed by the paper feed unit.

12. The printing apparatus according to claim 11, further comprising a reception unit configured to receive a device characteristic of the second printing apparatus to acquire the correction parameter.

13. A method for controlling a printing apparatus, the method comprising:
generating first print data and second print data based on input print data;
printing the generated first print data on a sheet;
acquiring, in order to print the second print data on the sheet having the first print data printed thereon while reducing misregistration, a correction parameter used for correcting a position of printing the second print data;
transmitting the generated second print data and the acquired correction parameter to a second printing apparatus; and
conveying the sheet having the first print data printed thereon to a paper feed unit of the second printing apparatus.

14. A method for controlling a printing apparatus, the method comprising:
generating first print data and second print data based on input print data;
acquiring a correction parameter used for correcting a position of printing the first print data;
transmitting the generated first print data and the acquired correction parameter to a second printing apparatus;
feeding a sheet having the first print data printed thereon from a paper feed unit of the second printing apparatus, the position of printing of the first print data being corrected by using the correction parameter; and
printing the second print data on the fed sheet.

15. A computer-readable storage medium storing computer-executable instructions which, when executed by a computer, cause the computer to perform the method according to claim 13.

16. A computer-readable storage medium storing computer-executable instructions which, when executed by a computer, cause the computer to perform the method according to claim 14.
